(19) United States
(12) Patent Application Publication
(10) Pub. No.: US 2025/0217608 A1
(43) Pub. Date: Jul. 3, 2025

(54) METHOD AND A DEVICE FOR AIDING CORRECT POINTING

(71) Applicant: INTACT S.L LTD., Corazim (IL)

(72) Inventors: Tomer NISSIMYAN, Corazim (IL); Meir RAPAPORT, Jerusalem (IL); Anthony Joseph WEISS, Tel Aviv (IL); Shai HOMSKY, Tel Aviv (IL)

(21) Appl. No.: 19/004,266

(22) Filed: Dec. 28, 2024

Related U.S. Application Data
(60) Provisional application No. 63/615,424, filed on Dec. 28, 2023.

(51) Int. Cl. G06K 7/10; G06K 19/07

(52) U.S. Cl. CPC G06K 7/10079; G06K 7/10039; G06K 19/0723

(57) ABSTRACT

A system comprising: an interrogator device and a responder device, each comprising at least one processor and a communications module comprising at least one RF transceiver and a directional antenna array; wherein the interrogator device is configured to generate and transmit a directional RF enquiry having a specified spatial volume in a direction-of-interest within an area-of-interest; wherein, when the responder device is located within the specified spatial volume, the responder device is configured to receive the RF enquiry and to transmit in a direction-of-arrival of the RF enquiry a directional RF response having encoded therein values associated with an electronic analysis of the RF enquiry; and wherein the interrogator device is configured to determine, based on an electronic analysis of the RF response and on the values encode din the RF response, whether the direction-of-interest intersects a predetermined volume-of-interest (VOI) defined relative to the responder device.

### CROSS-REFERENCE TO RELATED APPLICATIONS

This application claims the benefit of priority from U.S. Provisional Patent Application No. 63/615,424, filed Dec. 28, 2023, entitled, “A METHOD AND DEVICE FOR AIDING CORRECT POINTING,” the contents of which are hereby incorporated by reference in their entirety.

### FIELD OF THE INVENTION

The invention relates to the field of radio-frequency systems for determining position and orientation.

### BACKGROUND

Direction finding systems use radio frequency (RF) waves to determine the direction to a target of interest. Direction finding techniques can be based on RF signal amplitude, signal frequency, signal phase, signal timing, or a combination of these attributes. Direction finding has many useful civilian and military applications, including in marine and flight navigation, rescue missions, and the like.

A potentially useful application of RF-based direction finding technology may be as a mobile system for determining orientation of an interrogator relative to one or more targets-of-interest in within an area of deployment. Such a system would need to be realized as cost-effective and energy-efficient battery-operated mobile devices, which can be used in motion within the area of deployment, and provide a reasonable operating time per charge.

There are multiple challenges associated with such application of the technology, including overcoming the multipath reflections problem when operating in a reflective environment; the ability of the mobile devices to operate correctly regardless of possible changes in orientation and positioning while in motion during mobile deployment; and the need to manage energy consumption to ensure long operating time.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising an interrogator device comprising: at least one processor, and a communications module comprising at least one radio-frequency (RF) transceiver and a directional antenna array; and a responder device comprising: at least one processor, and a communications module comprising at least one radio-frequency (RF) transceiver and a directional antenna array, wherein the interrogator device is configured to generate and transmit a directional RF enquiry having a specified spatial volume in a direction-of-interest within an area-of-interest, wherein, when the responder device is located within the specified spatial volume of the RF enquiry, the responder device is configured to receive the RF enquiry and to generate and transmit in a direction-of-arrival of the RF enquiry a directional RF response having encoded therein values associated with an electronic analysis by the responder device of the received RF enquiry, and wherein the interrogator device is configured to determine, based, at least in part, on an electronic analysis of the RF response and on the values encoded in the RF response, whether the direction-of-interest intersects a predetermined volume-of-interest (VOI) defined relative to the responder device.

In some embodiments, the VOI comprises a virtual spatial volume designated surroundingly with respect to the responder device and defined as a three-dimensional virtual envelope extending between 20-500 cm in all directions relative to the responder device.

In some embodiments, the interrogator device is further configured to manipulate the RF enquiry to adapt the specified spatial volume based on a measured distance to the responder device, wherein, when the responder device is located within the adapted spatial volume, the responder device is configured to receive the RF enquiry, and to transmit in a direction-of-arrival of the RF enquiry a directional RF response having encoded therein values associated with an electronic analysis of the RF enquiry.

In some embodiments, the RF enquiry comprises two or more beams arranged in a predetermined pattern relative to the direction-of-interest, wherein the electronic analysis of the RF enquiry comprises determining a vector of distribution of measured values associated with each of the two or more beams.

In some embodiments, the interrogator device comprises comparing the vector of distribution to an expected vector of distribution when the RF enquiry is received by the responder device in direct transmission along the direction-of-interest.

In some embodiments, the respective electronic analyses of the RF enquiry and RF response comprise determining at least one of the following values with respect to each of the RF inquiry and RF response: received signal level (RSL), signal-to-noise (SNR) ratio values, amplitude, frequency, phase, and/or time-or-arrival.

In some embodiments, the RF enquiry and the RF response are each transmitted in a frequency of between 10-100 GHz.

In some embodiments, each of the directional antenna arrays of the interrogator and responder devices is configured to create an RF signal comprising one or more beams which can be electronically steered to point in any direction-of-interest.

In some embodiments, the measured distance to the responder device is based on a ranging operation between the interrogator device and the responder device.

In some embodiments, the determining by the interrogator device is based, at least in part, on a direction finding calculation, based on the electronic analysis of the RF response and on the values.

In some embodiments, the RF enquiry and the RF response each has further encoded therein at least one of the following datapoints, respectively, with respect to the interrogator device and the responder device: device ID, device location, device azimuthal direction relative to a reference azimuth, device angle of elevation relative to the horizontal plane, device altitude, device velocity, and/or device acceleration.

In some embodiments, the interrogator device and the responder device are each configured to normally operate in inactive mode, wherein the interrogator device is configured to only generate and transmit the RF enquiry upon a specified trigger event, wherein the responder device is only configured to switch into active mode only upon receiving the RF enquiry.

There is also provided, in an embodiment, a method comprising: providing an interrogator device comprising at least one processor, and a communications module comprising at least one radio-frequency (RF) transceiver and a directional antenna array; providing a responder device comprising at least one processor, and a communications module comprising at least one radio-frequency (RF) transceiver and a directional antenna array; generating and transmitting, by the interrogator device, a directional RF enquiry having a specified spatial volume in a direction-of-interest within an area-of-interest; receiving, by the responder device, when the responder device is located within the specified spatial volume of the RF enquiry, the RF enquiry; generating and transmitting, by the responder device, in a direction-of-arrival of the RF enquiry, a directional RF response having encoded therein values associated with an electronic analysis by the responder device of the received RF enquiry; and determining, by the interrogator device, based, at least in part, on an electronic analysis by the interrogator device of the RF response and on the values encoded in the RF response, whether the direction-of-interest intersects a predetermined volume-of-interest (VOI) defined relative to the responder device.

In some embodiments, the VOI comprises a virtual spatial volume designated surroundingly with respect to the responder device and defined as a three-dimensional virtual envelope extending between 20-500 cm in all directions relative to the responder device.

In some embodiments, the method further comprises (i) manipulating, by the interrogator device, the RF enquiry to adapt the specified spatial volume based on a measured distance to the responder device; (ii) receiving, by the responder device, when the responder device is located within the adapted spatial volume of the RF enquiry, the RF enquiry; and (iii) generating and transmitting, by the responder device, in a direction-of-arrival of the RF enquiry, a directional RF response having encoded therein values associated with an electronic analysis by the responder device of the received RF enquiry.

In some embodiments, the RF enquiry comprises two or more beams arranged in a predetermined pattern relative to the direction-of-interest, wherein the electronic analysis of the RF enquiry comprises determining a vector of distribution of measured values associated with each of the two or more beams.

In some embodiments, the determining by the interrogator device comprises comparing the vector of distribution to an expected vector of distribution when the RF enquiry is received by the responder device in direct transmission along the direction-of-interest.

In some embodiments, the respective electronic analyses of the RF enquiry and RF response comprise determining at least one of the following values with respect to each of the RF inquiry and RF response: received signal level (RSL), signal-to-noise (SNR) ratio values, amplitude, frequency, phase, and/or time-or-arrival.

In some embodiments, the RF enquiry and the RF response are each transmitted in a frequency of between 10-100 GHz.

In some embodiments, each of the directional antenna arrays of the interrogator and responder devices is configured to create an RF signal comprising one or more beams which can be electronically steered to point in any direction-of-interest.

In some embodiments, the method further comprises measuring, by the interrogator device, a distance to the responder device, based on a ranging operation between the interrogator device and the responder device.

In some embodiments, the determining by the interrogator device is based, at least in part, on a direction finding calculation, based on the electronic analysis of the RF response and on the values.

In some embodiments, the RF enquiry and the RF response each has further encoded therein at least one of the following datapoints, respectively, with respect to the interrogator device and the responder device: device ID, device location, device azimuthal direction relative to a reference azimuth, device angle of elevation relative to the horizontal plane, device altitude, device velocity, and/or device acceleration.

In some embodiments, the interrogator device and the responder device are each configured to normally operate in inactive mode, wherein the interrogator device is configured to only generate and transmit the RF enquiry upon a specified trigger event, wherein the responder device is only configured to switch into active mode only upon receiving the RF enquiry.

There if further provided, in an embodiment, a system comprising an interrogator device comprising at least one processor, and a communications module comprising at least one radio-frequency (RF) transceiver and a directional antenna array; and a plurality of responder devices, each comprising at least one processor, and a communications module comprising at least one radio-frequency (RF) transceiver and a directional antenna array, wherein the interrogator device is configured to generate and transmit a directional RF enquiry having a specified spatial volume in a direction-of-interest within an area-of-interest, wherein, each respective one of the plurality of responder devices that is located within the specified spatial volume of the RF enquiry, receives the RF enquiry and generates and transmits in a direction-of-arrival of the RF enquiry a directional RF response having encoded therein values associated with an electronic analysis by the respective responder device of the received RF enquiry, and wherein the interrogator device is configured to determine, based, at least in part, on an electronic analysis of each of the RF responses and on the values encoded in each of the RF response from each of the respective responder devices, whether the direction-of-interest intersects a predetermined volume-of-interest (VOI) defined relative to the respective responder device.

In some embodiments, the VOI comprises a virtual spatial volume designated surroundingly with respect to each of the plurality of responder devices and defined as a three-dimensional virtual envelope extending between 20-500 cm in all directions relative to the responder device.

In some embodiments, the interrogator device is further configured to manipulate the RF enquiry to adapt the specified spatial volume with respect to each of the respective responder devices, based on a measured distance to each of the respective responder devices, wherein each of the respective responder devices that is located within the respective adapted spatial volume receives the RF enquiry and generates and transmits in a direction-of-arrival of the RF enquiry a directional RF response having encoded therein values associated with an electronic analysis by the respective responder device of the received RF enquiry.

In some embodiments, the RF enquiry comprises two or more beams arranged in a predetermined pattern relative to the direction-of-interest, wherein the electronic analysis of the RF enquiry comprises determining a vector of distribution of measured values associated with each of the two or more beams.

In some embodiments, the determining by the interrogator device comprises comparing the vector of distribution to an expected vector of distribution when the RF enquiry is received in direct transmission along the direction-of-interest.

In some embodiments, the respective electronic analyses of the RF enquiry and RF response comprise determining at least one of the following values with respect to each of the RF inquiry and RF responses: received signal level (RSL), signal-to-noise (SNR) ratio values, amplitude, frequency, phase, and/or time-or-arrival.

In some embodiments, the RF enquiry and the RF responses are all transmitted in a frequency of between 10-100 GHz.

In some embodiments, each of the directional antenna arrays of the interrogator and responder devices is configured to create an RF signal comprising one or more beams which can be electronically steered to point in any direction-of-interest.

In some embodiments, the RF enquiry and the RF responses all have further encoded therein at least one of the following datapoints, respectively, with respect to the interrogator device and the responder device: device ID, device location, device azimuthal direction relative to a reference azimuth, device angle of elevation relative to the horizontal plane, device altitude, device velocity, and/or device acceleration.

In some embodiments, the interrogator device and each of the plurality of responder devices are all configured to normally operate in inactive mode, wherein the interrogator device is configured to only generate and transmit the RF enquiry upon a specified trigger event, wherein each of the plurality of responder devices is only configured to switch into active mode only upon receiving the RF enquiry.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIGS. 1A-1C and 2A-2C schematically depict exemplary scenarios in which the present technique may be implemented, in accordance with some embodiments of the present disclosure.

FIGS. 3A-3B schematically depict a multipath mitigation scheme, in accordance with some embodiments of the present disclosure.

FIG. 4 shows a block diagram of an exemplary interrogator device, according to some embodiments of the present disclosure.

FIG. 5A shows a block diagram of an exemplary responder device, according to some embodiments of the present disclosure.

FIG. 5B shows schematically depicts show an exemplary antenna module, according to some embodiments of the present disclosure.

FIG. 6 depicts overlapping beams A, B, which create an overlap beam AB, according to some embodiments of the present disclosure.

FIGS. 7A-7B depict the principle of an operational margin VOI at different measured distances., according to some embodiments of the present disclosure.

FIG. 8 is a flowchart which illustrates the functional steps in a method for precise determining of an orientation of an interrogator unit relative to one or more responders-of-interest within an area of deployment, based on radio frequency (RF) transmissions between the interrogator and the one or more responders, according to some embodiments of the present disclosure.

### DETAILED DESCRIPTION

Disclosed herein is a technique, embodied in a system and method, for precise determining of an orientation of an interrogator unit relative to one or more responders-of-interest within an area of deployment, based on radio frequency (RF) transmissions between the interrogator and the one or more responders.

In some embodiments, the present technique provides for determining whether a direction of orientation of the interrogator unit (its direction-of-interest) intersects a known or desired volume-of-interest (VOI) defined surroundingly relative to a responder-of-interest within the area of deployment, wherein VOI dimensions are distance-dependent. In some embodiments, the determining is based on calculating a spatial direction-of-arrival of one or more RF transmissions between the interrogator and a the responder-of-interest, based on a known predetermined VOI associated with the responder-of-interest at a known distance between the interrogator and the responder-of-interest.

As used herein, the term “direction-of-interest” refers to a line or axis extending linearly in any desired three-dimensional spatial direction from the interrogator device.

The term “volume-of-interest” or “VOI” refers to a virtual spatial volume designated surroundingly with respect to a responder-of-interest, defined as a three-dimensional virtual envelope extending from the responder-of-interest a predetermined span in all directions.

As used herein, the terms “directional,” “directivity,” and/or “spatial selectivity” refer to the degree to which an RF transmission emitted in an intended direction is concentrated in that direction. The term “directional RF beams” refers to an antenna designed to emit an RF beam in a single direction or over a narrow-angle. The term “spatial volume” refers to the spatial volume refers to the three-dimensional volume of RF transmission, as determined by its azimuth and elevation bandwidths.

In some embodiments, the specified VOI is configured to provide for a spatial 360 degree predetermined operational margin which envelopes the responder-of-interest, wherein the objective of the interrogator is to determine whether its direction-of-interest intersects this operational margin at a known distance to the responder.

An exemplary embodiment of the present system comprises an interrogator device and one or more responder devices. However, the principles of operation described herein with reference to the exemplary embodiment are equally applicable to other configurations of the present system, which may comprise any number of interrogator and responder devices.

In some embodiments, the interrogator and responder devices of the present system may be deployed as a mobile system in field operations, such as rescue, marine, aviation, military, or similar operations. In some embodiments, the interrogator and responder devices of the present system may be configured as mobile devices for equipping deployed operational units within an area of deployment, wherein each deployed operational unit may be designated as “interrogator” (and supplied with an interrogator device) and/or as “responder” (and supplied with a responder device). In some embodiments, the operational units may include, but are not limited to, personnel, land vehicles, airborne vehicles (such as UAV), marine vessels, or the like.

In some embodiments, an interrogator device of the present technique comprises an RF transceiver and an antenna array configured to transmit one or more directional RF beams in a direction-of-interest, wherein the RF beams define a three-dimensional spatial volume in the direction-of-interest. In some embodiments, an interrogator device of the present technique comprises an RF transceiver and an antenna array configured to transmit one or more directional RF beams in a direction-of-interest, wherein the RF beams can be manipulated to establish a desired spatial volume in the direction-of-interest, e.g., by adapting one or more properties of the beams (e.g., beam angle), so as to focus the spatial volume in the direction-of-interest. In some embodiments, an interrogator device of the present system comprises a transceiver configured to determine a spatial direction-of-arrival or bearing of an RF transmission, e.g., using any suitable radio direction-finding (DF) technique.

In some embodiments, a responder device of the present system comprises a transceiver and a receiving antenna configured to receive RF transmissions in all directions, e.g., an omnidirectional antenna array. In some embodiments, a responder device of the present system comprises a transceiver and a receiving antenna configured to receive RF transmissions in all directions, regardless of positioning or alignment of the receiving device on the body of or relative to the responder-designated operational unit equipped with the device.

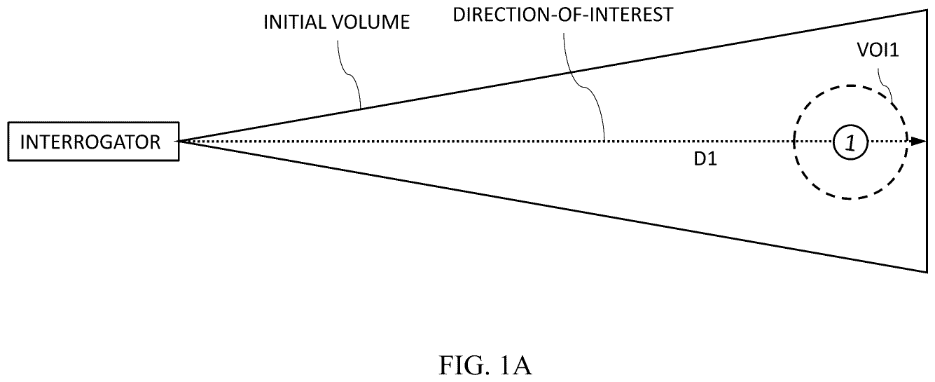

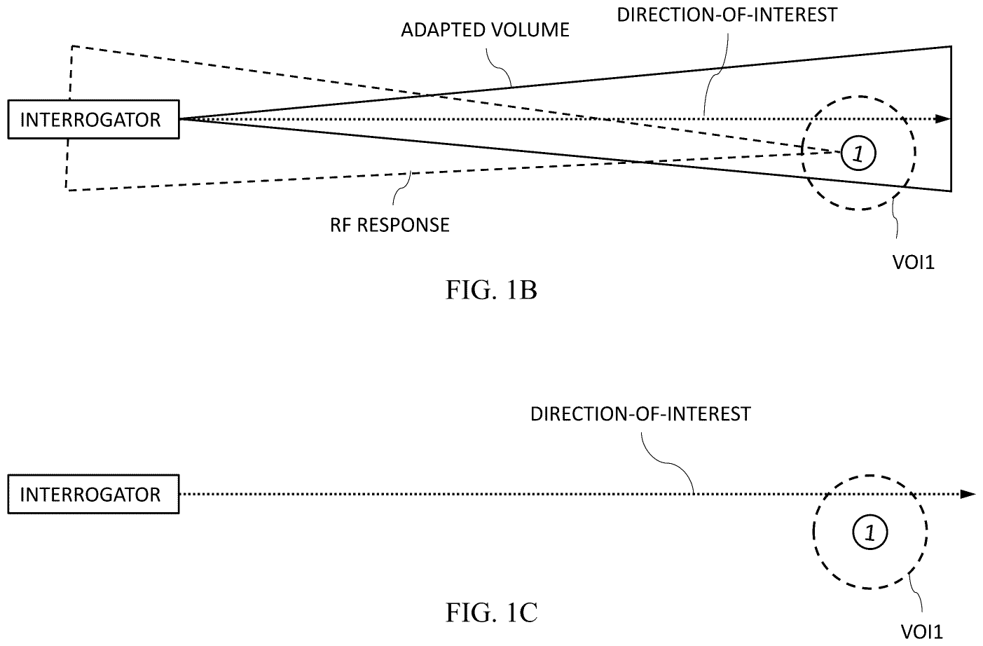

FIGS. 1A-1C schematically depict a first exemplary scenario in which the present system may be implemented.

With reference to FIG. 1A, in some embodiments, upon a trigger event, an interrogator unit equipped with an interrogator device of the present system transmits an RF enquiry in a specified direction-of-interest.

In some embodiments, the RF enquiry is formed as one or more directional beams defining an initial spatial volume in the direction-of-interest. In some embodiments, the initial spatial volume may be relatively wide, to establish the presence of potential one or more responders-of-interest within a predetermined lateral margin relative to the direction-of-interest.

The RF enquiry may be encoded with one or more datapoints associated with the RF enquiry and/or the interrogator device. For example, the RF enquiry may have encoded therein one or more of the following datapoints: location, azimuthal direction relative to a reference azimuth, angle of elevation relative to the horizontal plane, altitude, velocity, and/or acceleration, of the interrogator device.

In some embodiments, the RF enquiry from the interrogator device is received by one or more potential responders-of-interest located within the initial spatial volume of the RF enquiry.

In some embodiments, the RF enquiry comprises a ranging signal configured to perform a ranging operation to determine a distance to each of the potential responders-of-interest. The interrogator device then determines a distance to each of the responders-of-interest, based on RF responses received form each of the responders-of-interest. In some embodiments, the ranging operation is based on any suitable ranging method, such as two-way ranging that uses delays that occur in signal propagation to determine the range between the interrogator and each responder device.

In some embodiments, the interrogator device then optionally manipulates the spatial volume of the RF enquiry around the direction-of-interest, based on the measured distances to each of the responders-of-interest, to achieve a predetermined degree of spatial selectivity at each of the measured distances. For example, the interrogator device may decrease the spatial volume of the RF enquiry (e.g., by narrowing the angle of the RF enquiry one or more beam widths), to eliminate or filter-out potential responders-of-interest who are wide off the direction-of-interest at their respective measured distance, such that the direction-of-interest would be unlikely to intersect their VOI.

In this example, responder device 1 has a VOI1, and is located within the initial spatial volume (FIG. 1A). Upon narrowing of the initial spatial volume into the adapted spatial volume (FIG. 1B), responder device 1 continues to be located within the adapted spatial volume, and therefore becomes a responder-of-interest with respect to the interrogator device.

The RF response transmitted by responder 1 to the interrogator device may be encoded with one or more datapoints associated with the RF enquiry as received by responder device 1. For example, the RF response may have encoded therein one or more of the following datapoints: responder device unique ID, with a received signal strength (RSL), signal-to-noise ratio (SNR), amplitude, frequency, phase, and/or time-of-arrival of the one or more beams comprising the RF enquiry. In some embodiments, the RF response may have encoded therein one or more of the following datapoints: location, azimuthal direction relative to a reference azimuth, angle of elevation relative to the horizontal plane, altitude, velocity, and/or acceleration of the responder device.

With reference to FIG. 1C, the interrogator device then performs a direction finding calculation with respect to responder device 1, based, at least in part, on electronic analysis of the RF signals comprising the RF response and/or the data encoded in the RF response, to determine a spatial direction of the responder 1 relative to the interrogator device.

In some embodiments, based on the direction determination, the interrogator device determines that responder device 1 is located at a point wherein the direction-of-interest of the interrogator device intersects VOI1 of responder device 1 at distance D1.

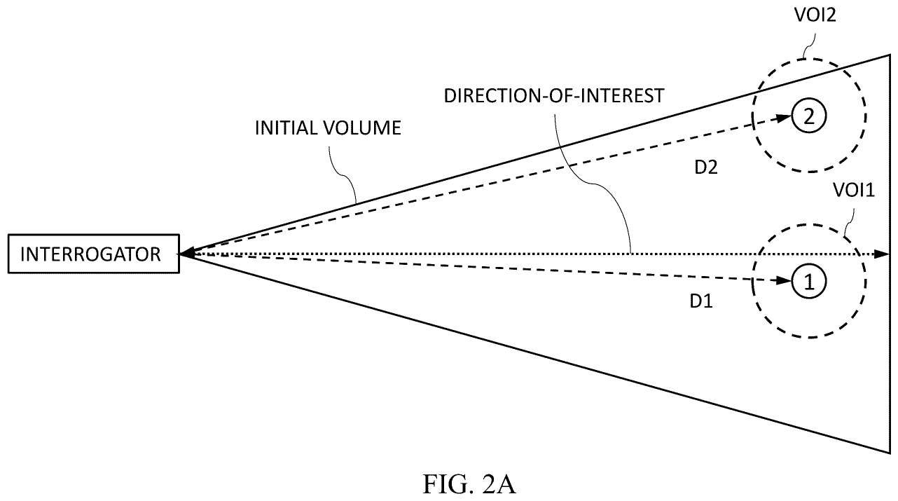

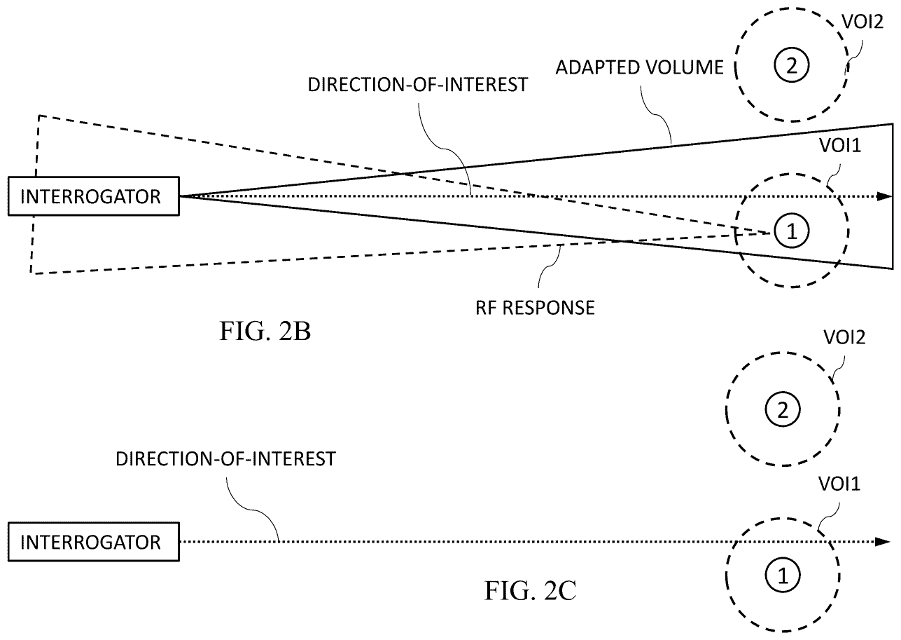

FIGS. 2A-2C schematically depict a different scenario in which the present system may be implemented.

With reference to FIG. 2A, in some embodiments, upon a trigger event, an interrogator unit equipped with an interrogator device of the present system, transmits an RF enquiry in a specified direction-of-interest. In some embodiments, the RF enquiry is formed as one or more directional beams defining an initial spatial volume in the direction-of-interest. In some embodiments, the initial spatial volume may be relatively wide, to establish the presence of potential one or more responders-of-interest within a predetermined lateral margin relative to the direction-of-interest.

In some embodiments, the RF enquiry from the interrogator device is received by one or more potential responders-of-interest located within the initial spatial volume of the RF enquiry.

In some embodiments, the RF enquiry comprises a ranging signal configured to perform a ranging operation to determine a distance to each of the potential responders-of-interest. The interrogator device then determines a distance to each of the responders-of-interest, based on RF responses received from each of the responders-of-interest. In some embodiments, the ranging operation is based on any suitable ranging method, such as two-way ranging that uses delays that occur in signal propagation to determine the range between the interrogator and each responder device.

In some embodiments, the interrogator device then optionally manipulates the spatial volume of the RF enquiry around the direction-of-interest, based on the measured distances to each of the responders-of-interest, to achieve a predetermined degree of spatial selectivity at each of the measured distances. For example, the interrogator device may decrease the spatial volume of the RF enquiry (e.g., by narrowing the angle of the RF enquiry one or more beam widths), to eliminate or filter-out potential responders-of-interest who are wide off the direction-of-interest at their respective measured distance, such that the direction-of-interest would be unlikely to intersect their VOI.

In this example, responder devices 1 and 2 have VOI1 and VOI2, respectively, and are both located within the initial spatial volume (FIG. 2A), at relatively similar distances D1 and D2, respectively. Upon narrowing of the initial spatial volume into the adapted spatial volume (FIG. 1B), responder device 1 continues to be located within the adapted spatial volume, and therefore becomes a responder-of-interest with respect to the interrogator device. However, responder 2 is no longer located within the adapted spatial volume, and therefore is not a responder-of-interest.

The RF response transmitted by responder 1 to the interrogator device may be encoded with one or more datapoints associated with the RF enquiry as received by responder device 1. For example, the RF response may have encoded therein one or more of the following datapoints: responder device unique ID, with a received signal strength (RSL), signal-to-noise ratio (SNR), amplitude, frequency, phase, and/or time-of-arrival of the one or more beams comprising the RF enquiry.

With reference to FIG. 2C, the interrogator device then performs a direction finding calculation with respect to responder device 1, based, at least in part, on electronic analysis of the RF signals comprising the RF response and/or the data encoded in the RF response, to determine a spatial direction of the responder 1 relative to the interrogator device.

In some embodiments, based on the direction determination, the interrogator device determines that responder device 1 is located at a point wherein the direction-of-interest of the interrogator device intersects VOI1 of responder device 1 at distance D1.

In some embodiments, the interrogator device of the present system is configured to normally operate in inactive or a similar energy-conserving mode. In some embodiments, the interrogator device of the present system is configured to switch into active mode and generate the RF enquiry only upon a specified trigger event, which may be initiated automatically (e.g., based on operator movement or posture), and/or based on operator command.

In some embodiments, the responder device of the present system is configured to normally operate in inactive or similar energy-conserving mode. In some embodiments, the responder device of the present system is configured to switch into active mode only upon receiving an RF enquiry from an interrogator device of the present system, e.g., based on a wake-on-Rx or similar mode.

In some embodiments, the interrogator and responder devices of the present system are configured to transmit the RF enquiry and RF response, respectively, as directional RF transmissions, each comprising one or more directional RF beams. In some embodiments, the interrogator and responder devices of the present system are configured to manipulate and/or adapt one or more RF beams comprising RF transmissions, to establish a desired spatial volume in a direction-of-interest. In some embodiments, the interrogator and responder devices of the present system are configured to employ any suitable RF signal processing method, such as beamforming, conical scanning, monopulse scanning, and the like.

In some embodiments, the interrogator and responder devices of the present system are configured to transmit the RF enquiry and RF response, respectively, in a specified band of frequencies within the electromagnetic spectrum, e.g., 60 GHz or between 10-130 GHz, so as to ensure high atmospheric and other attenuation of the RF transmissions within the area of deployment. In some embodiments, the high attenuation of the selected frequency band promotes security of the transmitted signals, by minimizing leakage of stray signals, as well as interference from other sources.

In some embodiments, the RF enquiry and RF response may be each encoded with specified information and data, such as a unique identifier assigned to the interrogator device and each of the responder devices.

In some embodiments, the RF enquiry and RF response may be encrypted using any suitable encryption technique, such as RSA or the like.

By way of background, a significant challenges of direction-finding in field operations is the multipath reflections problem. Waves transmitted from an RF transmitter may be scattered and reflected from objects in the environment, such as buildings, walls, vehicles, etc. the reflected waves may then arrive to a receiver from multiple directions, at different times and phases, and at different strength levels. These reflections may then be combined with the direct wave, and distort the amplitude, frequency, phase, and time of arrival of the RF signal.

Accordingly, in some embodiments, the present system provides for multipath-mitigating strategies.

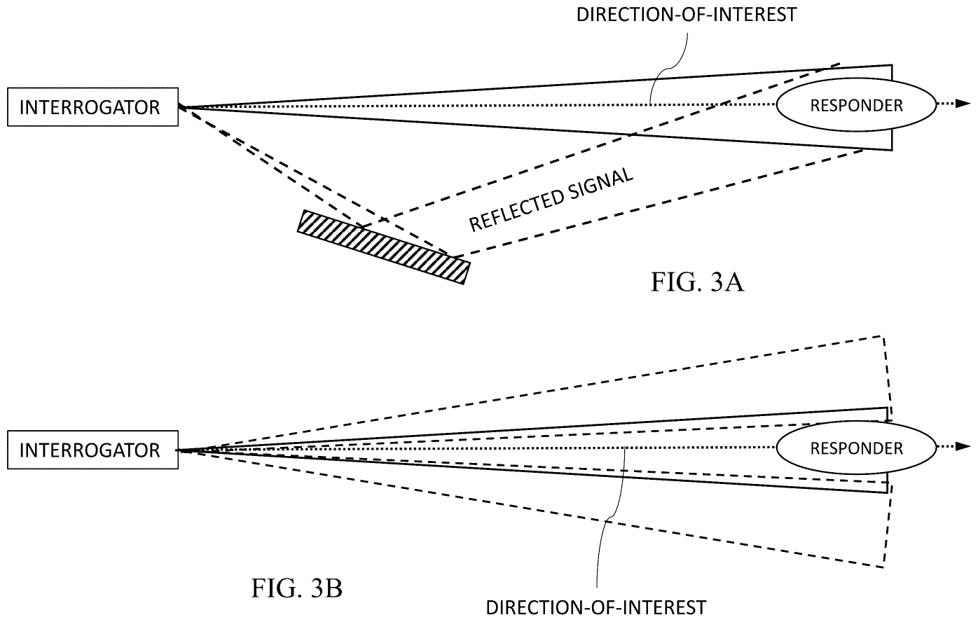

Reference is made to FIGS. 3A-3B which schematically depict a multipath mitigation scheme of the present technique. As can be seen in FIG. 3A, upon a trigger event, an interrogator device of the present system transmits an RF enquiry in a direction-of-interest. In some embodiments, The RF enquiry is formed as one or more directional beams, defining an initial spatial volume in the direction-of-interest. In some embodiments, the RF enquiry from the interrogator device is received by a responder located within the initial spatial volume of the RF enquiry. However, in some cases, the RF enquiry can be received by the responder through multiple paths. For example, one or more stray waves can reach the first responder as reflected signals and distort the attributes of the signal (e.g., amplitude, frequency, phase, time-of-arrival) which may cause an error in the direction finding calculation.

As can be seen in FIG. 3B, in some embodiments, the present technique provides for detecting and mitigating a potential multipath error, by transmitting an RF enquiry comprising two or more beams arranged in a predetermined pattern relative to said direction-of-interest. for example, the RF enquiry may comprise two or more, or multiple beams, which may comprise a central beam along a line-of-sight of the antenna array, as well as a plurality of beams, each of which is shifted slightly off center relative to the line-of-sight (which is generally identical to the direction-of-interest). For example, the RF enquiry may comprise a central beam and multiple off-center beams arranged in a rotating or any other desired pattern around the central beam. In some embodiments, the central and off-center beams may be at least partially overlapping. In some embodiments, the two or more, or multiple beams comprising the RF enquiry may be received by a responder device at expected differential transmission strengths, as may be indicated by measuring received signal level (RSL), signal-to-noise (SNR) ratio values, and/or one or more other signal attributes, such as amplitude, frequency, phase, time-or-arrival, and the like. In some embodiments, the vector of distribution of measured values of the two or more, or multiple beams as received by the responder device, may be encoded in an RF response transmitted by the responder device back to the interrogator device. In some embodiments, the interrogator device may compare the received encoded vector against an expected vector of distribution of values when the RF enquiry is received in a direct line-of-sight transmission. A deviation from the expected distribution of RSL values thus serves as indication that at least some of the received beams are reflection beams.

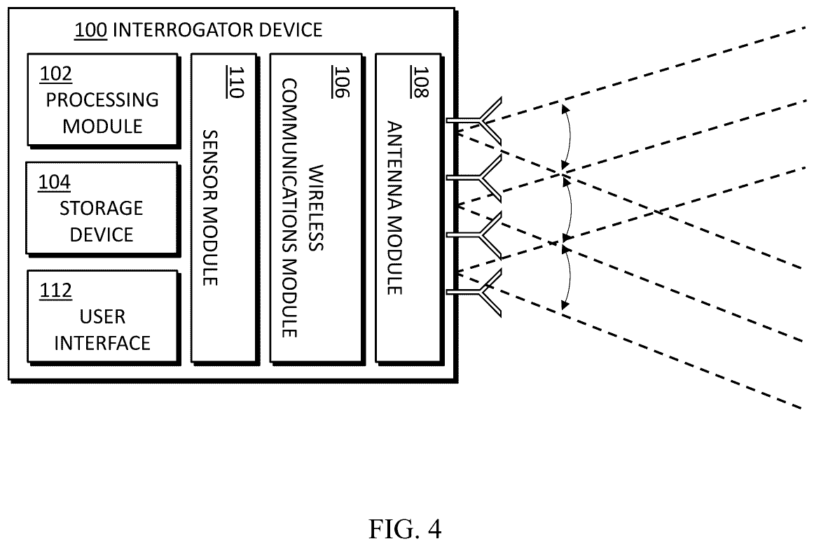

FIG. 4 shows a block diagram of an exemplary interrogator device 100, according to some embodiments of the present disclosure.

In some embodiments, interrogator device 100 may be any wireless device comprising at least a processor, a memory, an RF transceiver (or transmitter/receiver pair), and an antenna array configured to wirelessly communicate signals and data.

In an exemplary implementation, interrogator device 100 may include a processing module 102 including one or more hardware processors, a storage device 104, a wireless communications module 106, and antenna module 108, a sensor module 110, and an operator interface 112.

Processing module 102 may include components such as, but not limited to, one or more central processing units (CPUs), graphics processing units (GPUs), or any other suitable multi-purpose or specific processors or controllers. Processing module 102 may be operationally directly and/or indirectly connected to, and control the operation of, storage device 104, wireless communications module 106, antenna module 108, sensor module 110, and operator interface 112. Processing module 102 may be configured to receive data, signals, measurements, and/or any other information from storage device 104, wireless communications module 106, antenna module 108, sensor module 110, and operator interface 112. Processing module 102 may be configured to process and analyze such received data, signals, and measurements, and to operate storage device 104, wireless communications module 106, antenna module 108, sensor module 110, and operator interface 112 based on the results of this processing or analysis.

Storage device 104 may be or may include, for example, one or more non-transitory computer-readable storage device(s), a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Storage device 104 may have stored thereon program instructions and/or components configured to operate processing module 102. The storage instructions may be any executable code, e.g., a software application, a program, a process, task or script. The program instructions may include one or more software modules, and an operating system having various software components and/or drivers for controlling and managing general system tasks (e.g., memory management, storage device control, power management, etc.), and facilitating communication between various hardware and software components of device 100. Interrogator device 100 may operate by loading instructions of the various software modules stored on storage device 104 as they are being executed by processing module 102.

Wireless communications module 106 includes a radio frequency transceiver, comprising a radio transmitter and a radio receiver configured to transmit and receive radio waves in one or more desired RF frequency bands, using antenna module 108. Wireless communications module 106 may be configured to transmit and receive radio waves in a specified band of frequencies within the electromagnetic spectrum, e.g., 60 GHz or between 10-130 GHz, so as to ensure high atmospheric and other attenuation of the RF transmissions within an area of deployment. In some embodiments, the high attenuation of the selected frequency band promotes security of the transmitted signals, by minimizing leakage of stray signals, as well as interference from other sources.

In some embodiments, processing module 102 and/or wireless communications module 106 are configured to encode RF transmissions with specified information and data regarding interrogator device 100, such as a unique identifier assigned to the interrogator device, to each RF transmission, and/or to each RF beam within each RF transmission. In some embodiment, processing module 102 and/or wireless communications module 106 are configured to encode RF transmissions with additional specified information and data regarding interrogator device 100, including, but not limited to: location, azimuthal direction relative to a reference azimuth, angle of elevation relative to the horizontal plane, altitude, velocity, and/or acceleration. In some embodiments, these data may be obtained from sensor module 110.

In some embodiments, Wireless communications module 106 is configured to encrypt RF transmissions using any suitable encryption technique, such as RSA or the like.

In some embodiments, wireless communications module 106 is configured for powering antenna module 108, including but limited to an RF power supply and RF receiver. In some embodiments, wireless communications module 106 comprises a power divider for dividing power from wireless communications module 106 to each antenna comprising antenna module 108. In some embodiments, wireless communications module 106 can comprise any suitable number of RF transceivers, each of which can power one or more of the antennas comprising antenna module 108. In some embodiments, wireless communications module 106 further comprises a phase shifter configured to receive power and shift the phase of the power before conveying the power to antenna module 108.

In some embodiments, wireless communications module 106 comprises an RFID (radio-frequency identification) tag or any other suitable RF transceiver including but not limited to RF based tracking devices, ZigBee-based tracking devices, active RFID tags, passive RFID tags, semiactive RFID tags, and the like.

Antenna module 108 comprises any suitable or desired combination or array of one or more antenna elements, such as directional antenna elements or omni-directional antenna elements for communication between systems and/or transferring data in the form of wireless communication. In some embodiments, antenna module 108 comprises any suitable antenna configured to transmit or receive directional radio waves. In one example, antenna module 108 comprises a phased antenna array which may be controlled by wireless communications module 106 to create one or more beams of radio waves which can be electronically steered to point in different directions.

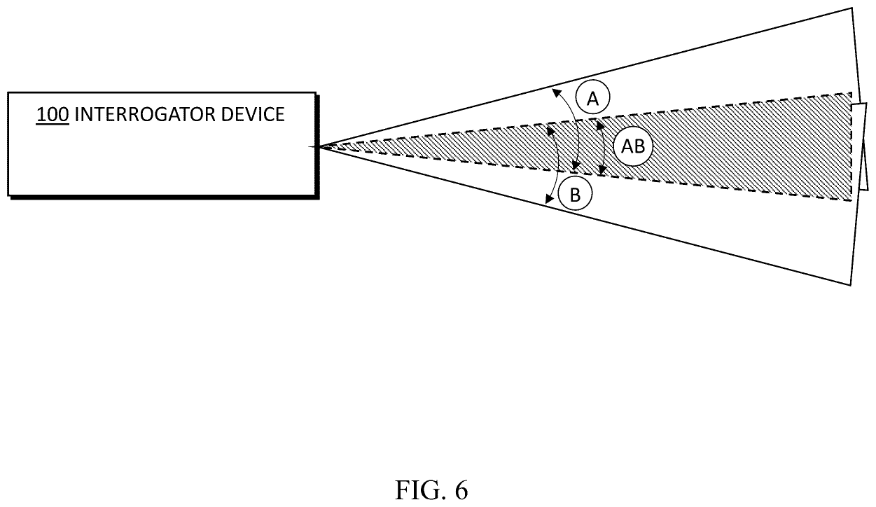

In some embodiments, antenna module 108 may be controlled by processing module 102 and/or wireless communications module 106 to manipulate and/or adapt an RF beam emitted by antenna module 108, to establish a desired spatial volume in a direction-of-interest, e.g., by adapting a width of the beam. In some embodiments, antenna module 108 may be controlled by processing module 102 and/or wireless communications module 106 to manipulate and/or adapt an RF beam emitted by antenna module 108 to establish a desired spatial volume in a direction-of-interest, using any suitable RF signal processing method, such as beamforming, conical scanning, monopulse scanning, and the like. For example, as shown in FIG. 6, antenna module 108 may be controlled by processing module 102 and/or wireless communications module 106 to transmit an RF signal comprising two or more overlapping beams A, B, which create an overlap beam AB. The width of overlap beam AB can be manipulated by adapting beams A, B.

In some embodiments, antenna module 108 comprises a phased array of antennas enabled to transmit and receive power at a given frequency for communicating with an RF. In some embodiments, antenna module 108 is moveable in one or more planes, e.g., in a scanning fashion, and/or rotatable. In some embodiments, antenna module 108 comprises any desired number of antenna elements, which can be any suitable type of antenna of any suitable dimensions. In some embodiments, each antenna element may be mounted in the same plane, however, in other implementations each antenna element can be at any suitable angle to one another in both the vertical and horizontal directions relative to the direction-of-interest in which antenna module 108 is pointed.

In some embodiments, power radiated by each antenna can be polarized (e.g., linearly polarized or circularly polarized) or unpolarized as desired. In some embodiments, antenna module 108 can operate at any suitable frequency, or range of frequencies, for communicating with an RF transponder.

In some embodiments, antenna module 108 is configured to transmit a RF signals comprising one or more beams, wherein each beam may have azimuth beamwidth of 1°-30° and an elevation beamwidth of 1°-30°.

In some embodiments, the effective power radiated by antenna module 108 can be in a range from 10-10,000 mW. However, the power output radiated by antenna module 108 is not to be considered particularly limiting.

In some embodiments, interrogator device 100 comprises a sensor module 110 comprising one or more sensors configured for determining a location, motion, posture, and/or orientation of interrogator device 100. Sensor module 110 may calculate these values based, at least in part, on measurements relating to location, altitude, velocity, linear and rotational acceleration, and/or spatial orientation of interrogator device 100. In some embodiments, sensor module 110 comprises multiple sensors, such as one or more inertial measurement unit (IMU), accelerometers, gyroscopes, temperature sensor, barometer, compass, and/or a global positioning system (GPS) sensor.

Interrogator device 100 may further comprise an operator interface module 112, comprising, e.g., a display, audio output, indicator lights, and operator input mechanisms such as buttons, a touchscreen, a keypad, or the like.

Interrogator device 100 may further comprise any suitable or desired input/output means or devices, such as a wired or wireless network interface card, a universal serial bus (USB) port, external memory unit, or the like.

Interrogator device 100 may be a mobile device configured for equipping a mobile operational unit within an area of deployment. In one example, interrogator device 100 may be a mobile device mounted to an operational unit, or attachable to an article of clothing or gear worn by a person, or to a piece of equipment mounted to or carried on or by an operational unit.

In some embodiments, interrogator device 100 may be carried by operational units in a specified position and orientation, such that antenna module 108 is oriented so as to emit directional RF transmissions in a designated direction-of-interest of the operational unit. For example, in some embodiments, interrogator device 100 may be aligned with a line-of-sight of optical equipment of the operational unit.

Interrogator device 100 may be battery-powered, using any suitable rechargeable or other battery of the types know in the art. In some embodiments, interrogator device 100 is configured to normally operate in inactive or similar energy-conserving mode. In some embodiments, interrogator device 100 is configured to switch into active mode and generate the RF enquiry only upon a specified trigger event, which may be initiated automatically (e.g., based on operator movement or posture), and/or based on operator command. Interrogator device 100 may be encased in an enclosure comprising one or more tampering-proof means. For example, interrogator device 100 may be configured to erase all stored data upon detection of a tampering attempt.

In some embodiments, interrogator device 100 may include one or more time-dependent self-erasing mechanisms. For example, interrogator device 100 may be programmed to self-erase after a specified period of time in which no designated “keep alive” signal is received by interrogator device 100.

Interrogator device 100 as described herein is only an exemplary embodiment of the present invention, and in practice may be implemented in hardware only, software only, or a combination of both hardware and software. In various embodiments, interrogator device 100 may comprise a dedicated hardware device, or may be implement as a hardware and/or software module into an existing device, e.g., any suitable mobile device. Interrogator device 100 may have more or fewer components and modules than shown, may combine two or more of the components, or may have a different configuration or arrangement of the components. Interrogator device 100 may include any additional component enabling it to function as an operable computer system, such as a motherboard, data busses, power supply, a network interface card, a display, an input device (e.g., keyboard, pointing device, touch-sensitive display), etc. (not shown).

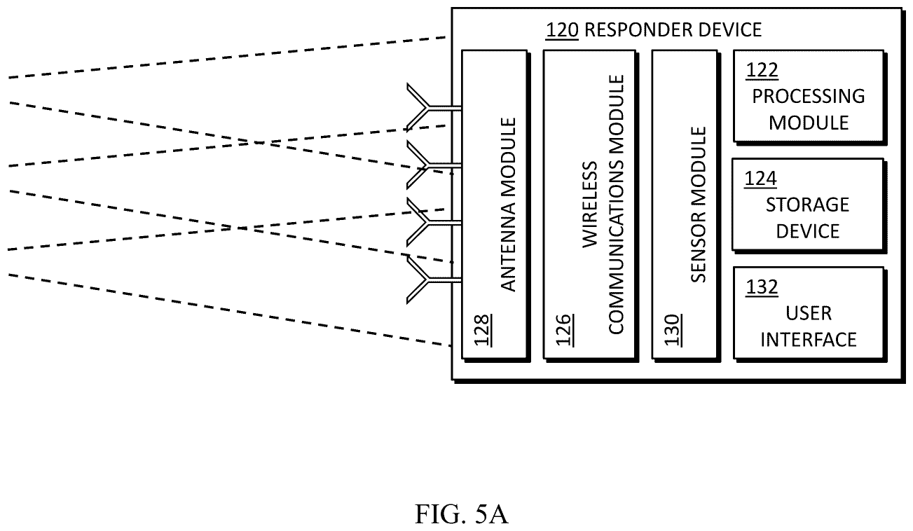

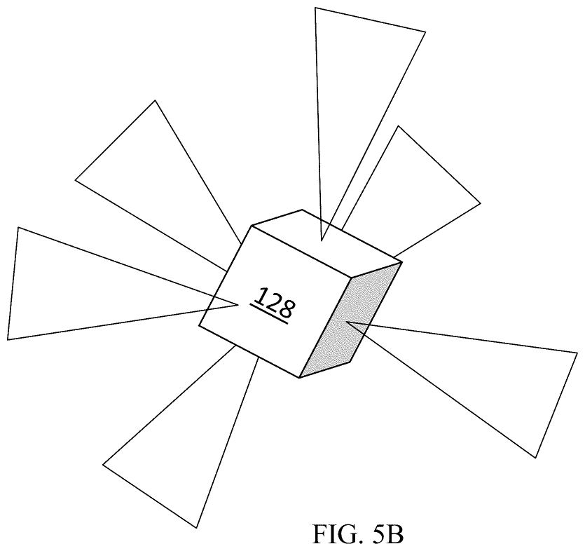

FIG. 5 shows a block diagram of an exemplary responder device 120, according to some embodiments of the present disclosure.

In some embodiments, responder device 120 may be any wireless device comprising at least a processor, a memory, an RF transceiver (or transmitter/receiver pair), and an antenna array configured to wirelessly communicate signals and data.

In an exemplary implementation, responder device 120 may include a processing module 122 including one or more hardware processors, a storage device 124, a wireless communications module 126, and antenna module 128, a sensor module 130, and an operator interface 112.

Processing module 122 may include components such as, but not limited to, one or more central processing units (CPUs), graphics processing units (GPUs), or any other suitable multi-purpose or specific processors or controllers. Processing module 122 may be operationally directly and/or indirectly connected to, and control the operation of, storage device 124, wireless communications module 126, antenna module 128, sensor module 130, and operator interface 132. Processing module 122 may be configured to receive data, signals, measurements, and/or any other information from storage device 124, wireless communications module 126, antenna module 128, sensor module 130, and operator interface 112. Processing module 122 may be configured to process and analyze such received data, signals, and measurements, and to operate storage device 124, wireless communications module 126, antenna module 128, sensor module 130, and operator interface 132 based on the results of this processing or analysis.

Storage device 124 may be or may include, for example, one or more non-transitory computer-readable storage device(s), a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Storage device 124 may have stored thereon program instructions and/or components configured to operate processing module 122. The storage instructions may be any executable code, e.g., a software application, a program, a process, task or script. The program instructions may include one or more software modules, and an operating system having various software components and/or drivers for controlling and managing general system tasks (e.g., memory management, storage device control, power management, etc.), and facilitating communication between various hardware and software components of device 120. Responder device 120 may operate by loading instructions of the various software modules stored on storage device 124 as they are being executed by processing module 122.

Wireless communications module 126 includes a radio frequency transceiver, comprising a radio transmitter and a radio receiver configured to transmit and receive radio waves in one or more desired RF frequency bands, using antenna module 128. Wireless communications module 126 may be configured to transmit and receive radio waves in a specified band of frequencies within the electromagnetic spectrum, e.g., 60 GHz or between 10-130 GHz, so as to ensure high atmospheric and other attenuation of the RF transmissions during field operation. In some embodiments, the high attenuation of the selected frequency band promotes security of the transmitted signals, by minimizing leakage of stray signals, as well as interference from other sources.

In some embodiments, processing module 122 and/or wireless communications module 126 are configured to encode RF transmissions with specified information and data regarding interrogator device 120, such as a unique identifier assigned to the interrogator device, to each RF transmission, and/or to each RF beam within each RF transmission. In some embodiment, processing module 122 and/or wireless communications module 126 are configured to encode RF transmissions with additional specified information and data regarding interrogator device 120, including, but not limited to: location, azimuthal direction relative to a reference azimuth, angle of elevation relative to the horizontal plane, altitude, velocity, and/or acceleration. In some embodiments, these data may be obtained from sensor module 130.

In some embodiments, wireless communications module 126 is configured for powering antenna module 128, including but limited to an RF power supply and RF receiver. In some embodiments, wireless communications module 126 comprises a power divider for dividing power from wireless communications module 126 to each antenna comprising antenna module 128. In some embodiments, wireless communications module 126 can comprise any suitable number of RF transceivers, each of which can power one or more of the antennas comprising antenna module 128. In some embodiments, wireless communications module 126 further comprises a phase shifter configured to receive power and shift the phase of the power before conveying the power to antenna module 128.

In some embodiments, wireless communications module 126 comprises an RFID (radio-frequency identification) tag or any other suitable RF transceiver including but not limited to RF based tracking devices, ZigBee-based tracking devices, active RFID tags, passive RFID tags, semiactive RFID tags, and the like.

Antenna module 128 comprises any suitable or desired combination or array of one or more antenna elements, such as directional antenna elements or omni-directional antenna elements for communication between systems and/or transferring data in the form of wireless communication. In some embodiments, antenna module 128 comprises any suitable antenna or an array of antenna elements configured to transmit or receive directional radio waves. In one example, antenna module 128 comprises an antenna array configured for use in direction finding, to determine a direction-of-arrival or bearing of a radio signal received by antenna module 128.

In one example, antenna module 128 may comprise an array of antenna elements configured for use in direction finding in two or more planes and/or omnidirectionally. Thus, antenna module 128 may be able to determine direction of arrival of an RF transmission, regardless of the positioning or alignment of responder device 120 relative to the horizontal plane.

In some embodiments, antenna module 128 comprises a phased array of antennas enabled to transmit and receive power at a given frequency for communicating with an RF. In some embodiments, antenna module 128 is moveable in one or more planes, e.g., in a scanning fashion, and/or rotatable. In some embodiments, antenna module 128 comprises any desired number of antenna elements, which can be any suitable type of antenna of any suitable dimensions. In some embodiments, each antenna element may be mounted in the same plane, however, in other implementations each antenna element can be at any suitable angle to one another in both thew vertical and horizontal directions relative to the direction-of-interest in which antenna module 128 is pointed.

Reference is made to FIG. 5B, which schematically depicts show an exemplary antenna module 128. In some embodiments, antenna module 128 comprises up to 6 independent directional antenna arrays, configured to transmit an RF response in respective up to 6 directions. For example, antenna module 128 comprises up to 6 independent directional antenna arrays, configured to transmit an RF response in respective up to 6 directions relative to a spatial position of responder device 120—e.g., up, down, left, right, front, back. In some embodiments, wireless communications module 126 and antenna module 128 are configured to transmit the RF response only in the direction-of-arrival of the RF enquiry, using a respective one of the independent directional antenna arrays.

In some embodiments, the RF transmission between interrogator device 100 and responder device 120 are based on the physical layer of Wi-Fi 802.11ad/ay. Thus, interrogator device 100 and responder device 120 are able to use the Wi-Fi collision avoidance mechanisms listed below, to ensure appropriate handling of simultaneous RF enquiries or RF responses received from multiple interrogator devices 100 and/or responder devices 120, respectively:
CSMA/CA.
Backoff Mechanism.
Directional RTS.

In some embodiments, power radiated by each antenna can be polarized (e.g., linearly polarized or circularly polarized) or unpolarized as desired. In some embodiments, antenna module 128 can operate at any suitable frequency, or range of frequencies, for communicating with an RF transponder.

In some embodiments, antenna module 108 is configured to transmit a RF signals comprising one or more beams, wherein each beam may have azimuth beamwidth of 1°-30° and an elevation beamwidth of 1°-30°.

In some embodiments, the power radiated by antenna module 128 can be in a range from 10-10,000 mW. However, the power output radiated by antenna module 128 is not to be considered particularly limiting.

In some embodiments, responder device 120 comprises a sensor module 130 comprising one or more sensors configured for determining a location, motion, posture, and/or orientation of responder device 120. Sensor module 130 may calculate these values based, at least in part, on measurements relating to location, altitude, velocity, linear and/or rotational acceleration, and/or spatial orientation of responder device 120. In some embodiments, sensor module 130 comprises multiple sensors, such as one or more inertial measurement unit (IMU), accelerometers, gyroscopes, temperature sensor, barometer, compass, and/or a global positioning system (GPS) sensor.

Responder device 120 may further comprise an operator interface module 132, comprising, e.g., a display, audio output, indicator lights, and operator input mechanisms such as buttons, a touchscreen, a keypad, or the like.

Responder device 120 may further comprise any suitable or desired input/output means or devices, such as a wired or wireless network interface card, a universal serial bus (USB) port, external memory unit, or the like.

Responder device 120 may be a mobile device configured for equipping operational units in field deployment. In some embodiments, the operational units may include, but are not limited to, personnel, land vehicles, airborne vehicles (such as UAV), marine vessels, or the like.

In one example, responder device 120 may be a mobile device mounted to an operational unit, or attachable to an article of clothing or gear worn by a person, or to a piece of equipment mounted to or carried on or by an operational unit.

Responder device 120 may be battery-powered, using any suitable rechargeable or other battery of the types know in the art. In some embodiments, responder device 120 is configured to normally operate in inactive or similar energy-conserving mode. In some embodiments, responder device 120 is configured to switch into active mode only upon sensing or receiving an RF enquiry from an interrogator device, such as interrogator device 100, e.g., based on a wake-on-Rx or similar mode. Responder device 120 may be encased in an enclosure comprising one or more tampering-proof means. For example, responder device 120 may be configured to erase all stored data upon detection of a tampering attempt.

In some embodiments, responder device 120 may include one or more time-dependent self-erasing mechanisms. For example, responder device 120 may be programmed to self-erase after a specified period of time in which no designated “keep alive” signal is received by responder device 120.

Responder device 120 as described herein is only an exemplary embodiment of the present invention, and in practice may be implemented in hardware only, software only, or a combination of both hardware and software. In various embodiments, responder device 120 may comprise a dedicated hardware device, or may be implement as a hardware and/or software module into an existing device, e.g., any suitable mobile device. Responder device 120 may have more or fewer components and modules than shown, may combine two or more of the components, or may have a different configuration or arrangement of the components. Responder device 120 may include any additional component enabling it to function as an operable computer system, such as a motherboard, data busses, power supply, a network interface card, a display, an input device (e.g., keyboard, pointing device, touch-sensitive display), etc. (not shown).

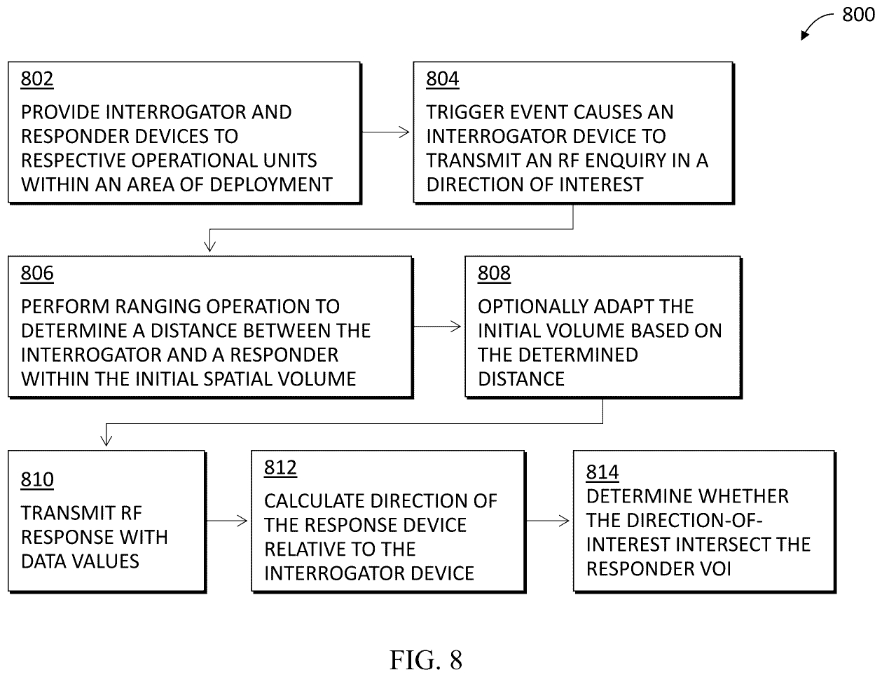

FIG. 8 is a flowchart which illustrates the functional steps in a method 800 for precise determining of an orientation of an interrogator unit relative to one or more responders-of-interest within an area of deployment, based on radio frequency (RF) transmissions between the interrogator and the one or more responders.

In some embodiments, method 800 provides for determining whether a direction of orientation of the interrogator unit (its direction-of-interest) intersects a specified known volume-of-interest (VOI) defined relative to a responder-of-interest within the area of deployment. As used herein, the term “direction-of-interest” refers to a line or axis extending in any desired three-dimensional spatial direction from the interrogator device. In some embodiments, the determining is based on calculating a spatial direction of arrival of an RF enquiry from the interrogator device as received by a responder-of-interest and reported back to the interrogator device.

The various steps of method 800 will be described with continuous reference to exemplary interrogator device 100 shown in FIG. 4, and to exemplary responder device 120 shown in FIGS. 5A-5B. The various steps of method 800 may either be performed in the order they are presented or in a different order (or even in parallel), as long as the order allows for a necessary input to a certain step to be obtained from an output of an earlier step. In addition, One or more steps of method 800 may be performed automatically (e.g., by interrogator device 100 and/or responder device 120), unless specifically stated otherwise.

The various steps of method 800 will be described with reference to a scenario in which an interrogator operational unit within an area of deployment uses an interrogator device, such as interrogator device 100, to determine whether one or more responder operational unit are located with a volume-of-interest defined relative to the direction-of-interest of the interrogator operational unit and/or the interrogator device 100. However, the principles of operation described herein are equally applicable to other scenarios which may comprise any number of interrogator and responder operational unit within an area of deployment.

Method 800 begins in step 802, when at least one operational unit is designated as an “interrogator” within an area of deployment, and is provided with an interrogator device, such as exemplary interrogator device 100. Similarly, at least one operational unit is designated as a “responder” within the area of deployment, and is provided with a responder device, such as exemplary responder device 120. Interrogator devices 100 and responder devices 120 may each be mounted to or carried by their respective operational units.

In some embodiments, interrogator device 100 and responder device 120 are both normally operating in inactive or a similar energy-conserving mode, in which communications modules 106 and 126, respectively, do not transmit continually, but rather only upon a trigger event or operator command.

In step 804, interrogator device 100 may be operated to transmit an RF enquiry in a spatial direction-of-interest determined by the interrogator operational unit.

In some embodiments, an interrogator unit manually operates interrogator device 100 to transmit an RF enquiry in a direction-of-interest determined by the interrogator operational unit. For example, the interrogator operational unit may cause interrogator device 100 (or a piece of gear or equipment to which interrogator device 100 is mounted or attached) to be oriented in the direction-of-interest, and issue a suitable command to operate interrogator device 100, e.g., via operator interface 112, which causes interrogator device 100 to transmit an RF enquiry.

In other examples, interrogator device 100 may be configured to perform step 804 automatically, based on one or more specified trigger events detected by interrogator device 100. For example, when interrogator device 100 determines that the device and/or the interrogator operational unit to which it is mounted has assumed a specified location, position, posture, or orientation, and/or initiated a specified motion sequence. This may be determined, e.g., based on data received from sensor module 110 with respect to location, azimuthal direction relative to a reference azimuth, angle of elevation relative to the horizontal plane, altitude, velocity, and/or acceleration of interrogator device 100.

In some embodiments, the RF enquiry is formed as one or more directional beams having a specified beam angle and defining an initial spatial volume in the direction-of-interest. In some embodiments, as can be seen with reference back to FIG. 3B, the RF enquiry comprises two or more, or multiple beams, which may comprise a central beam along the direction-of-interest, as well as a plurality of beams, each of which is shifted slightly off center relative to the direction-of-interest. For example, the RF enquiry may comprise a central beam and multiple off-center beams arranged in a rotating or any other desired pattern around the central beam. In some embodiments, the central and off-center beams may be at least partially overlapping.

The RF enquiry may be encoded with one or more datapoints associated with the RF enquiry and/or the interrogator device 100. For example, the RF enquiry may have encoded therein one or more of the following datapoints: location, azimuthal direction relative to a reference azimuth, angle of elevation relative to the horizontal plane, altitude, velocity, and/or acceleration, of interrogator device 100.

In some embodiments, the RF enquiry from the interrogator device is received by a first responder equipped with a responder device 120, located within the initial spatial volume of the RF enquiry. This is shown schematically in FIG. 1A.

In some embodiments, the RF enquiry is transmitted in a specified band of frequencies within the electromagnetic spectrum, e.g., 60 GHz or between 10-130 GHz, so as to ensure high atmospheric and other attenuation of the RF transmissions within the area of deployment. In some embodiments, the high attenuation of the selected frequency band promotes security of the transmitted signals, by minimizing leakage of stray signals, as well as interference from other sources.

In some embodiments, processing module 102 and/or wireless communications module 106 are configured to encode the RF enquiry with a unique identifier assigned to the interrogator device, to each RF transmission, and/or to each RF beam within each RF transmission. In some embodiment, processing module 102 and/or wireless communications module 106 are configured to encode the RF enquiry with additional specified information and data regarding interrogator device 100, including, but not limited to: location, azimuthal direction relative to a reference azimuth, angle of elevation relative to the horizontal plane, altitude, velocity, and/or acceleration. In some embodiments, these data may be obtained from sensor module 110.

In some embodiments, the RF enquiry transmission may be encrypted using any suitable encryption technique, such as RSA or the like.

In some embodiments, the RF enquiry beam has a high bandwidth, e.g., on the order of 1-10 GHz, for example 4 GHz.

In some embodiments, interrogator device 100 may be configured to apply to the RF enquiry various signal processing techniques, such as direct sequence spread spectrum (DSSS), frequency hopping (FHSS), and burst communication.

In step 806, interrogator device 100 is configured to perform a ranging operation, to determine a distance between interrogator device 100 and the responder device 120 located within the initial spatial volume. In some embodiments, the RF enquiry from interrogator device 100 comprises a ranging signal configured to perform a ranging operation to determine a distance between interrogator device 100 and responder device 120 located within the initial spatial volume, based, e.g., on a response ranging signal from the responder device 120. In some embodiments, the ranging operation is based on any suitable ranging method, such as two-way ranging that uses delays that occur in signal propagation to determine the range between the interrogator and the first responder. However, in other cases, the ranging operation may be based on other data, such as data encoded in the RF enquiry and/or an RF response transmitted by responder device 120.

In step 808, with reference back to FIG. 1B, interrogator device 100 then optionally manipulates the initial spatial volume of the RF enquiry, based on the detected distance to responder device 120. For example, interrogator device 100 may optionally manipulate the initial spatial volume of the RF enquiry, based on the detected distance, to achieve a desired degree of spatial selectivity at that distance. For example, interrogator device 100 may decrease the spatial volume of the RF enquiry (e.g., by narrowing the angle of the RF enquiry one or more beam widths), to eliminate or filter-out potential other responders within the initial spatial volume, because the interrogator device determines that these responders are wide off the direction-of-interest at their respective measured distance, and its direction-of-interest is unlikely to intersect a known VOI (i.e., operational margin envelope) for each of these responders.

In some embodiments, two or more responder device 120 may be dispersed laterally within a small area, all at substantially the same distance from interrogator device 100. In such cases, the groups of two or more responders may be located within the initial spatial volume. However, the optional adapting of the initial spatial volume of the RF enquiry may help to eliminate one or more of the responders as potential responders-of-interest, when they are determined to be well outside the adapted spatial volume.

In other cases, two or more responder device 120 may be dispersed laterally within a small area, however, at varying distances from interrogator device 100. In such cases, steps 804-808 may need to be repeated with respect to each such responder, to determine whether it is a responder-of-interest. However, steps 804-808 involve a series of very short RF transmissions and computer calculations. Therefore these steps are expected to be performed very rapidly by the respective devices, on the magnitude of a few seconds or less. Thus, these steps can be repeated multiple times by one or more interrogator devices 100 deployed in an area of deployment. Thus, for example, an interrogator device 100 may perform successively the steps of method 800 with respect to a first responder device 120, then a second responder device 120, a third, and so on, in rapid succession and without affecting the effectiveness of method 800.

In some embodiments, interrogator device 100 manipulates or adapts a beam of the RF enquiry to achieve an adapted spatial volume according to a desired spatial selectivity in the direction-of-interest, relative to the detected distance. For example, the specified spatial volume may be based on a desired operational margin relative to a detected responder within the initial spatial volume. Such desired operational margin may be indicated as a specified volume-of-interest (VOI) defined relative to a responder. In some embodiments, the specified VOI is configured to provide for a spatial 360 degree predetermined operational margin which envelopes the responder. For example, the VOI may be set to extend between 20-500 cm in all directions relative to the responder.

In some embodiments, interrogator device 100 manipulates or adapts a beam of the RF enquiry to achieve an adapted spatial volume according to a predetermined distance-dependent spatial selectivity relative to known VOI dimension. In some embodiments, distance-dependent spatial selectivity values relative to known VOI dimensions may be predetermined for each interrogator device 100 and stored thereon as, e.g., a predetermined table of values on device 104.

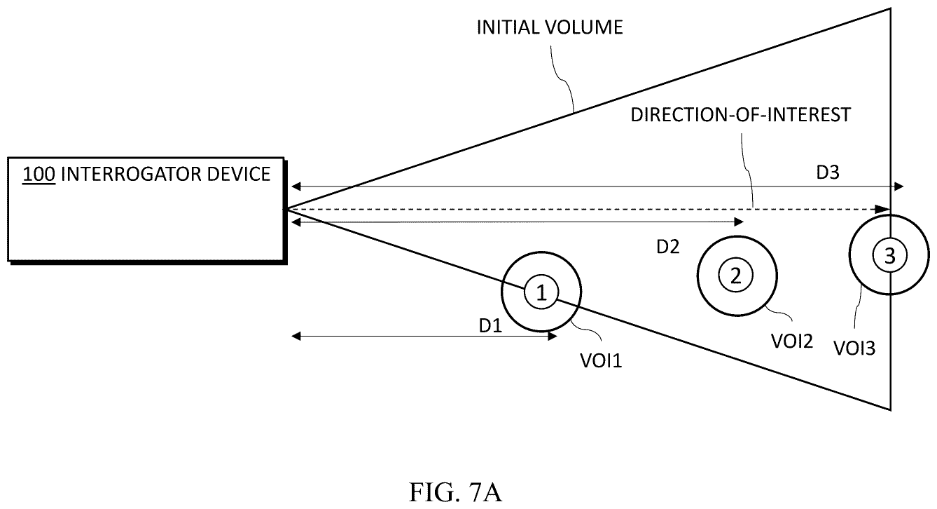

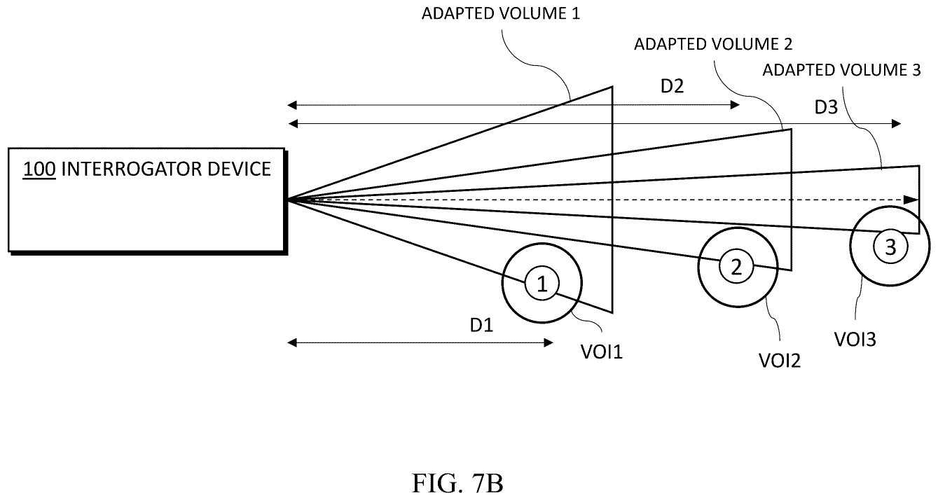

FIGS. 7A-7B depict the principle of an operational margin VOI at different measured distances.

As can be seen in FIG. 7A, interrogator device 100 transmits an RF enquiry in a direction-of-interest having an initial spatial volume. Three potential responders-of-interest 1, 2, and 3 are located within the initial spatial volume, at respective measured distances D1, D2, and D3 from interrogator device 100. Each of the three responders 1, 2, and 3 is associated with an identical operational margin envelope VOI1, VOI2, or VOI3, respectively.

In FIG. 7B, based on a ranging operation with respect to responder 1, interrogator device 100 may set a first adapted spatial volume which corresponds to known VOI dimensions at distance D1, e.g., based on a predetermined table of values. As can be seen, responder 1 falls within the first adapted spatial beam volume at distance D1 based on its VOI1, and is therefore a responder-of-interest for operational purposes with respect to interrogator device 100.

Then, based on a ranging operation with respect to responder 2, interrogator device 100 may set a second adapted spatial volume which corresponds to known VOI dimensions at distance D2, e.g., based on a predetermined table of values. Because distance D2 is greater than D1, the adapted spatial volume can be decreased while still maintaining the operational margin VOI at distance D2 relative to the direction-of-interest. Thus, irrelevant responders located closer outside of the narrower RF enquiry beam will not need to be interrogated at that distance. As can be seen, responder 2 falls within the second adapted spatial beam volume at distance D2 based on its VOI2, and is therefore a responder-of-interest for operational purposes with respect to interrogator device 100. Responder 1 at distance D1 does not fall within the second adapted spatial beam volume.

Then, based on a ranging operation with respect to responder 3, interrogator device 100 may set a third adapted spatial volume which corresponds to known VOI dimensions at distance D2, e.g., based on a predetermined table of values. Because distance D3 is greater than D2, the adapted spatial volume can be decreased further while still maintaining the operational margin VOI at that distance relative to the direction-of-interest. Thus, irrelevant responders located outside of the narrow RF enquiry beam will not need to be interrogated at that distance. As can be seen, responder 3 falls within the third adapted spatial beam volume at distance D3 based on its VOI3, and is therefore a responder-of-interest for operational purposes with respect to interrogator device 100. Responders 1 and 2 do not fall within the third adapted spatial beam volume.

In step 810, with continued reference to FIG. 1B, responder device 120 may then transmit an RF response to interrogator device 100, which may have encoded therein one or more datapoints associated with responder device 120 and the RF enquiry, as received by responder device 120. For example, the RF response may have encoded therein one or more of the following datapoints: unique identifier assigned to responder device 120, to the RF response, and/or to each RF beam within the RF response.

In some embodiments, the RF response is formed as one or more directional beams having a specified beam angle and defining an initial spatial volume in the direction-of-arrival of the RF enquiry.

In some embodiments, the RF response may have further encoded therein one or more additional datapoints, including: a received signal strength (RSL), signal-to-noise ratio (SNR), amplitude, frequency, phase, and/or time-of-arrival, of the one or more beams comprising the RF enquiry.

In some embodiments, the RF response encoded data may be based on electronic analysis of the RF signals comprising the RF enquiry transmitted by interrogator device 100, as received at two or more antennas comprising antenna module 128 of responder device 120.

In some embodiments, the RF response may have encoded therein one or more of the following additional datapoints with respect to responder device 120: location, azimuthal direction relative to a reference azimuth, angle of elevation relative to the horizontal plane, altitude, velocity, and/or acceleration of responder device 120. In some embodiments, these data may be obtained from sensor module 130.

As noted above, with reference back to FIG. 3B, optionally, the RF enquiry is formed as one or more directional beams having a specified beam angle and defining an initial spatial volume in the direction-of-interest. In some embodiments, as can be seen with reference back to FIG. 3B, the RF enquiry comprises two or more, or multiple beams, which may comprise a central beam along the direction-of-interest, as well as a plurality of beams, each of which is shifted slightly off center relative to the direction-of-interest. For example, the RF enquiry may comprise a central beam and multiple off-center beams arranged in a rotating or any other desired pattern around the central beam. In some embodiments, the central and off-center beams may be at least partially overlapping.

In some embodiments, when transmitted a direct line-of-sight transmission, the RF enquiry may be received by responder device 120 at expected differential transmission strengths, as may be indicated by measuring received signal level (RSL), signal-to-noise (SNR) ratio values, and/or one or more other signal attributes, such as amplitude, frequency, phase, time-or-arrival, and the like.

In some embodiments, the vector of distribution of measured values of the two or more, or multiple beams as received by responder device 120, may be encoded in the RF response. In some embodiments, interrogator device 100 may compare the received vector as encoded in the RF response against an expected vector of distribution of values when the RF enquiry is received in a direct line-of-sight transmission, to determine whether the RF enquiry was received by responder device 120 in a direct line-of-sight transmission, or whether at least some of the received beams are reflection multipath beams.

In some embodiments, the RF response is transmitted in a specified band of frequencies within the electromagnetic spectrum, e.g., 60 GHz or between 10-130 GHz, so as to ensure high atmospheric and other attenuation of the RF transmissions within the area of deployment. In some embodiments, the high attenuation of the selected frequency band promotes security of the transmitted signals, by minimizing leakage of stray signals, as well as interference from other sources.

In some embodiments, the RF response may be encoded with specified information and data, such as a unique identifier assigned to the interrogator device and each of the responder devices.

In some embodiments, the RF response may be encrypted using any suitable encryption technique, such as RSA or the like.

In some embodiments, the RF response beam has a high bandwidth, e.g., on the order of 1-10 GHz, for example 4 GHz.

In some embodiments, responder device 120 may be configured to apply a random delay before transmitting the RF response, e.g., between 1 to 1,000 milliseconds.

In some embodiments, the responder device 120 may be configured to apply to the RF response various signal processing techniques, such as direct sequence spread spectrum (DSSS), frequency hopping (FHSS), and burst communication.

With reference back to FIG. 5B, in some embodiments, the RF response from responder device 120 is transmitted only in the direction-of-arrival of the RF enquiry, using a respective one of the independent directional antenna arrays comprising antenna module 128. Thus, for example, when the RF enquiry or portions thereof is not received in a direction line of sight transmission, but is rather the result of stray multipath signals, the RF response will be transmitted I the direction from which the stray signals arrive.

In step 812, interrogator device 100 performs a direction finding calculation with respect to responder device 120, based, at least in part, on an electronic analysis of the RF signals comprising the RF response received from the responder device 120, and/or the data encoded in the RF response, to determine a spatial direction of responder device 120 relative to interrogator device 100.

For example, responder device 120 may be configured to employ any suitable direction finding or similar techniques, based, at least in part, on an electronic analysis of the RF signals comprising the RF response received from the responder device 120, and/or the data encoded in the RF response, to determine a spatial direction of responder device 120 relative to interrogator device 100. Such techniques may be amplitude-based direction finding techniques measure the level of the received signal (e.g., based on RSL or RSSI measures) using a multi-array antenna, and calculate from these amplitude differences the angle of arrival of the signal. In another example, interrogator device 100 may use phase-based direction finding techniques, which measure the phase difference of the arrival of a signal by multiple antennas, and calculate from these phase differences the angle of arrival of the signal. Yet other example is time-based direction finding techniques.

Optionally, in some embodiments, the direction finding calculation may be based, at least in part, on applying a trained machine learning model to electronic analysis of the RF signals comprising the RF response received from the responder device 120 and/or the data encoded in the RF response.

In some embodiments, a trained machine learning model of the present technique is trained on a training dataset comprising data and measurements associated with a plurality of received patterns of RF signals representing a respective plurality of RF enquiries transmitted by one or more interrogator devices 100, and received by one or more responder device 120, as well as RF responses transmitted by one or more responder device 120 and received by one or more interrogator devices 100.

In some embodiments, the training dataset is annotated with labels indicating a ‘ground truth’ spatial direction or bearing of each of responder device 120 relative to each interrogator device 100.

In some embodiments, a trained machine learning model of the present technique may be applied to data and measurements associated with electronic analysis of the RF signals comprising an RF response received from a responder device 120 by an interrogator device 100, and/or any other data encoded in the RF response. In some embodiments, the trained machine learning model is configured to output a prediction indicating a spatial direction or bearing of each of responder device 120 relative to each interrogator device 100.

In step 814, based on the spatial direction or bearing of responder device 120 relative to interrogator device 100, interrogator device 100 determines whether responder device 120 is located at a point wherein the direction-of-interest of interrogator device 100 intersects the VOI of responder device 120 at the determined distance.

In some embodiments, interrogator device 100 may issue a suitable indication, signal, or notification to the interrogator operational unit operating interrogator device 100, e.g., through operator interface 112, when it is determined that responder device 120 is located at a point wherein the direction-of-interest of interrogator device 100 intersects the VOI of responder device 120 at the determined distance.

The steps of method 800 involve a series of very short RF transmissions and computer calculations. The method as a whole is therefore expected to be performed very rapidly by the respective devices, on the magnitude of a few seconds or less. It is expected that the steps of method 800 can be thus repeated multiple times by one or more interrogator devices 100 deployed in an area of deployment, each with respect to multiple responder devices 120 located within the area of deployment. Thus, for example, an interrogator device 100 may perform successively the steps of method 800 with respect to a first responder device 120, then a second responder device 120, a third, and so on.

In some cases, the steps of method 800 may be performed concurrently or in rapid succession between an interrogator device 100 and two or more responder devices 120. For example, upon a trigger event, interrogator device 100 transmits an RF enquiry in an azimuthal direction-of-interest. The RF enquiry is received by two or more responder devices 120. Interrogator device 100 may perform a ranging operation to determine the distance between interrogator device 100 and each respective responder device 120 located within the initial spatial volume. Interrogator device 100 may then manipulate the initial spatial volume of the RF enquiry, based on the detected range to each of the respective responder devices 120. This step may be performed sequentially, e.g., for each responder device 120 in turn, for example, from the nearest to the most distant, in any different order, or in any random fashion. Each responder device then performs a direction finding calculation to determine the azimuthal direction from which the RF enquiry arrived, and transmits an RF response to interrogator device 100. Interrogator device 100 then determines, separately with respect to each responder device 120, whether the respective responder is located within its respective adapted spatial volume.

In some embodiments, the present technique provides for avoiding interference among multiple interrogators and responders communicating simultaneously within an area of deployment. As noted with reference to FIG. 5B, wireless communications module 126 and antenna module 128 are configured to transmit the RF response only in the direction-of-arrival of the RF enquiry, using a respective one of the independent directional antenna arrays. Thus, only the relevant interrogator device will receive the RF response form the responder device. in addition, the RF transmissions between interrogator devices 100 and responder devices 120 are based on the physical layer of Wi-Fi 802.11ad/ay. Thus, interrogator devices 100 and responder devices 120 are able to use the Wi-Fi collision avoidance mechanisms listed below, to ensure appropriate handling of simultaneous RF enquiries or RF responses received from multiple interrogator devices 100 and/or responder devices 120, respectively:
CSMA/CA.
Backoff Mechanism.
Directional RTS.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Rather, the computer readable storage medium is a non-transient (i.e., not-volatile) medium.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, a field-programmable gate array (FPGA), or a programmable logic array (PLA) may execute the computer readable program instructions by utilizing state information of the computer readable program instructions to personalize the electronic circuitry, in order to perform aspects of the present invention. In some embodiments, electronic circuitry including, for example, an application-specific integrated circuit (ASIC), may be incorporate the computer readable program instructions already at time of fabrication, such that the ASIC is configured to execute these instructions without programming.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the description and claims, each of the terms “substantially,” “essentially,” and forms thereof, when describing a numerical value, means up to a 20% deviation (namely, ±20%) from that value. Similarly, when such a term describes a numerical range, it means up to a 20% broader range-10% over that explicit range and 10% below it).

In the description, any given numerical range should be considered to have specifically disclosed all the possible subranges as well as individual numerical values within that range, such that each such subrange and individual numerical value constitutes an embodiment of the invention. This applies regardless of the breadth of the range. For example, description of a range of integers from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 4, and 6. Similarly, description of a range of fractions, for example from 0.6 to 1.1, should be considered to have specifically disclosed subranges such as from 0.6 to 0.9, from 0.7 to 1.1, from 0.9 to 1, from 0.8 to 0.9, from 0.6 to 1.1, from 1 to 1.1 etc., as well as individual numbers within that range, for example 0.7, 1, and 1.1.

The descriptions of the various embodiments of the present invention have been presented for purposes of illustration, but are not intended to be exhaustive or limited to the explicit descriptions. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise,” “include,” and “have,” as well as forms thereof, are not necessarily limited to members in a list with which the words may be associated.

Where there are inconsistencies between the description and any document incorporated by reference or otherwise relied upon, it is intended that the present description controls.

What is claimed is:

1. A system comprising:
an interrogator device comprising:
at least one processor, and
a communications module comprising at least one radio-frequency (RF) transceiver and a directional antenna array; and
a responder device comprising:
at least one processor, and
a communications module comprising at least one radio-frequency (RF) transceiver and a directional antenna array,
wherein said interrogator device is configured to generate and transmit a directional RF enquiry having a specified spatial volume in a direction-of-interest within an area-of-interest,
wherein, when said responder device is located within said specified spatial volume of said RF enquiry, said responder device is configured to receive said RF enquiry and to generate and transmit in a direction-of-arrival of said RF enquiry a directional RF response having encoded therein values associated with an electronic analysis by said responder device of said received RF enquiry, and
wherein said interrogator device is configured to determine, based, at least in part, on an electronic analysis of said RF response and on said values encoded in said RF response, whether said direction-of-interest intersects a predetermined volume-of-interest (VOI) defined relative to said responder device.

2. The system of claim 1, wherein said VOI comprises a virtual spatial volume designated surroundingly with respect to said responder device and defined as a three-dimensional virtual envelope extending between 20-500 cm in all directions relative to said responder device.

3. The system of claim 1, wherein said interrogator device is further configured to manipulate said RF enquiry to adapt said specified spatial volume based on a measured distance to said responder device, and wherein, when said responder device is located within said adapted spatial volume, said responder device is configured to receive said RF enquiry, and to transmit in a direction-of-arrival of said RF enquiry a directional RF response having encoded therein values associated with an electronic analysis of said RF enquiry.

4. The system of claim 1, wherein said RF enquiry comprises two or more beams arranged in a predetermined pattern relative to said direction-of-interest, wherein said electronic analysis of said RF enquiry comprises determining a vector of distribution of measured values associated with each of said two or more beams, and wherein said determining by said interrogator device comprises comparing said vector of distribution to an expected vector of distribution when said RF enquiry is received by said responder device in direct transmission along said direction-of-interest.

5. The system of claim 1, wherein said respective electronic analyses of said RF enquiry and RF response comprise determining at least one of the following values with respect to each of said RF inquiry and RF response: received signal level (RSL), signal-to-noise (SNR) ratio values, amplitude, frequency, phase, and/or time-or-arrival.

6. The system of claim 1, wherein said determining by said interrogator device is based, at least in part, on a direction finding calculation, based on said electronic analysis of said RF response and on said values.

7. The system of claim 1, wherein said RF enquiry and said RF response each has further encoded therein at least one of the following datapoints, respectively, with respect to said interrogator device and said responder device: device ID, device location, device azimuthal direction relative to a reference azimuth, device angle of elevation relative to the horizontal plane, device altitude, device velocity, and/or device acceleration.

8. A method comprising:
providing an interrogator device comprising:
at least one processor, and
a communications module comprising at least one radio-frequency (RF) transceiver and a directional antenna array;
providing a responder device comprising:
at least one processor, and
a communications module comprising at least one radio-frequency (RF) transceiver and a directional antenna array;
generating and transmitting, by said interrogator device, a directional RF enquiry having a specified spatial volume in a direction-of-interest within an area-of-interest;
receiving, by said responder device, when said responder device is located within said specified spatial volume of said RF enquiry, said RF enquiry;
generating and transmitting, by said responder device, in a direction-of-arrival of said RF enquiry, a directional RF response having encoded therein values associated with an electronic analysis by said responder device of said received RF enquiry; and
determining, by said interrogator device, based, at least in part, on an electronic analysis by said interrogator device of said RF response and on said values encoded in said RF response, whether said direction-of-interest intersects a predetermined volume-of-interest (VOI) defined relative to said responder device.

9. The method of claim 8, wherein said VOI comprises a virtual spatial volume designated surroundingly with respect to said responder device and defined as a three-dimensional virtual envelope extending between 20-500 cm in all directions relative to said responder device.

10. The method of claim 8, further comprising:
(i) manipulating, by said interrogator device, said RF enquiry to adapt said specified spatial volume based on a measured distance to said responder device;
(ii) receiving, by said responder device, when said responder device is located within said adapted spatial volume of said RF enquiry, said RF enquiry; and
(iii) generating and transmitting, by said responder device, in a direction-of-arrival of said RF enquiry, a directional RF response having encoded therein values associated with an electronic analysis by said responder device of said received RF enquiry.

11. The method of claim 8, wherein said RF enquiry comprises two or more beams arranged in a predetermined pattern relative to said direction-of-interest, wherein said electronic analysis of said RF enquiry comprises determining a vector of distribution of measured values associated with each of said two or more beams, and wherein said determining by said interrogator device comprises comparing said vector of distribution to an expected vector of distribution when said RF enquiry is received by said responder device in direct transmission along said direction-of-interest.

12. The method of claim 8, wherein said respective electronic analyses of said RF enquiry and RF response comprise determining at least one of the following values with respect to each of said RF inquiry and RF response: received signal level (RSL), signal-to-noise (SNR) ratio values, amplitude, frequency, phase, and/or time-or-arrival.

13. The method of claim 8, wherein said determining by said interrogator device is based, at least in part, on a direction finding calculation, based on said electronic analysis of said RF response and on said values.

14. The method of claim 8, wherein said RF enquiry and said RF response each has further encoded therein at least one of the following datapoints, respectively, with respect to said interrogator device and said responder device: device ID, device location, device azimuthal direction relative to a reference azimuth, device angle of elevation relative to the horizontal plane, device altitude, device velocity, and/or device acceleration.

15. A system comprising:
an interrogator device comprising:
at least one processor, and
a communications module comprising at least one radio-frequency (RF) transceiver and a directional antenna array; and
a plurality of responder devices, each comprising:
at least one processor, and
a communications module comprising at least one radio-frequency (RF) transceiver and a directional antenna array,
wherein said interrogator device is configured to generate and transmit a directional RF enquiry having a specified spatial volume in a direction-of-interest within an area-of-interest,
wherein, each respective one of said plurality of responder devices that is located within said specified spatial volume of said RF enquiry, receives said RF enquiry and generates and transmits in a direction-of-arrival of said RF enquiry a directional RF response having encoded therein values associated with an electronic analysis by said respective responder device of said received RF enquiry, and
wherein said interrogator device is configured to determine, based, at least in part, on an electronic analysis of each of said RF responses and on said values encoded in each of said RF response from each of said respective responder devices, whether said direction-of-interest intersects a predetermined volume-of-interest (VOI) defined relative to said respective responder device.

16. The system of claim 15, wherein said VOI comprises a virtual spatial volume designated surroundingly with respect to each of said plurality of responder devices and defined as a three-dimensional virtual envelope extending between 20-500 cm in all directions relative to said responder device.

17. The system of claim 15, wherein said interrogator device is further configured to manipulate said RF enquiry to adapt said specified spatial volume with respect to each of said respective responder devices, based on a measured distance to each of said respective responder devices, and wherein each of said respective responder devices that is located within said respective adapted spatial volume receives said RF enquiry and generates and transmits in a direction-of-arrival of said RF enquiry a directional RF response having encoded therein values associated with an electronic analysis by said respective responder device of said received RF enquiry.

18. The system of claim 15, wherein said RF enquiry comprises two or more beams arranged in a predetermined pattern relative to said direction-of-interest, wherein said electronic analysis of said RF enquiry comprises determining a vector of distribution of measured values associated with each of said two or more beams, and wherein said determining by said interrogator device comprises comparing said vector of distribution to an expected vector of distribution when said RF enquiry is received in direct transmission along said direction-of-interest.

19. The system of claim 15, wherein said respective electronic analyses of said RF enquiry and RF response comprise determining at least one of the following values with respect to each of said RF inquiry and RF responses: received signal level (RSL), signal-to-noise (SNR) ratio values, amplitude, frequency, phase, and/or time-or-arrival.

20. The system of claim 15, wherein said RF enquiry and said RF responses all have further encoded therein at least one of the following datapoints, respectively, with respect to said interrogator device and said responder device: device ID, device location, device azimuthal direction relative to a reference azimuth, device angle of elevation relative to the horizontal plane, device altitude, device velocity, and/or device acceleration.
